(19) United States
(12) Patent Application Publication
(10) Pub. No.: US 2024/0428263 A1
(43) Pub. Date: Dec. 26, 2024

(54) Compliance Management System And Method Using A No-Code Approach

(71) Applicant: LiveApplication, Inc., Seoul (KR)

(72) Inventors: Inhyang Yoo, Incheon (KR); Hyungdeok Han, Gwangmyeong (KR); Minjun Kim, Ansan (KR)

(21) Appl. No.: 18/620,305

(22) Filed: Mar. 28, 2024

(30) Foreign Application Priority Data
Mar. 29, 2023 (KR) 10-2023-0041329
Jan. 31, 2024 (KR) 10-2024-0014558

(51) Int. Cl. G06Q 30/018

(52) U.S. Cl. CPC G06Q 30/018

(57) ABSTRACT

The present disclosure relates to compliance management system and method using a no-code approach, which enables flexible response to a compliance change without coding, based on a server-client structure. The compliance management system using the no-code approach includes a compliance management server processing a request from a compliance management client to provide a compliance management function using the no-code approach. The compliance management server includes a unit policy management module, a compliance classification item management module, a compliance evaluation item management module, and an implementation inspection project management module.

### TECHNICAL FIELD

The present disclosure relates to a compliance management system and method, and more specifically, to a compliance management system and method using a no-code approach that enables flexible response to a compliance change without coding, based on a server-client structure.

### BACKGROUND

Financial institutions, medical institutions, public institutions, and general corporations should operate transparently in accordance with various laws, regulations, and policies required in their industries. A regulatory process that each institution or company should comply with is referred to as compliance (policy of law observance, compliance monitoring, internal control, etc.). Each institution or company must comply with various compliance requirements required by supervisory institutions or certification institutions and must submit a report to the relevant supervisory institutions or certification institutions proving that they have complied. Failure to comply with compliance or negligence in submitting reports may result in disqualification, sanctions, and restrictions on business activities. Thus, an institution or a company is entrusting specialized compliance management companies to manage its compliance implementation history.

Typically, general companies or institutions must comply with one or more compliance requirements, while financial institutions are subject to more compliance requirements compared to other industries. The compliance that financial institutions should comply with to provide financial services may include Anti-Money Laundering (AML) compliance, Know-Your-Customer (KYC) compliance, transaction record preservation compliance, local regulatory compliance, etc. Further, the compliance that financial institutions should comply with to provide electronic (IT) financial services may include personal information protection-related compliance, e-finance infrastructure security vulnerability assessment compliance, e-finance transaction law-related compliance, Information Security Management System (ISMS) compliance, ISMS-P certification compliance based on ISO/IEC 27001, financial information protection continuous evaluation system compliance, technical vulnerability analysis and assessment compliance of key information and communication infrastructure, and Financial Supervisory Service certification and verification compliance.

The e-finance infrastructure security vulnerability assessment compliance is classified into 3 categories, 11 control areas, and 43 control categories based on the Financial IT Security Compliance Guide (October 2017, Financial Security Institute), and consists of 681 evaluation items. The three categories include administrative security, technical security, and physical security, and the 11 control areas include information security policy, information security organization, personnel security, business continuity management, external order security, operation management, access control, IT introduction/development/maintenance management, electronic financial transaction security, security incident response, and physical/environmental security. The 681 evaluation items are classified into 3 categories, 11 control areas, and 43 control categories, and are regulated based on the Electronic Financial Transactions Act, the Enforcement Decree of the Electronic Financial Transactions Act, the Electronic Financial Supervision Regulations, the Enforcement Rules of the Electronic Financial Supervision Regulations, and the Key Information and Communication Infrastructure Vulnerability Analysis Evaluation Criteria. A unique evaluation item identification ID is assigned to each evaluation item.

Meanwhile, the Financial Information Protection Continuous Evaluation System Compliance includes 143 evaluation items classified into 9 major items and 31 medium items regarding personal information protection-related measures and information security-related measures. Each evaluation item is assigned a serial number that includes classified major and medium item information. As the major items, it includes ‘1. Principles and methods of consent to personal credit information’, ‘2. Collection of personal credit information’, ‘3. Provision of personal credit information’, ‘4. Retention and deletion of personal credit information’, ‘5. Protection of rights of credit information subjects’, ‘6. Entrustment of personal credit information processing’, ‘7. Administrative protection measures for personal credit information’, ‘8. Technical protection measures for personal credit information’, and ‘9. Protection measures for pseudonymized information’. The major item ‘1. Principles and methods for consent to personal credit information’ includes three medium items: ‘1.1. Mandatory notification items when consenting to information use’, ‘1.2. Mandatory/optional consent methods when consenting to information use’, and ‘1.3. Summary principles for notification items and consent levels when consenting to information use’. The medium item of 1.1 includes four evaluation items, each of which is assigned a serial number of 1.1.1, 1.1.2, 1.1.3, and 1.1.4. The medium item of 1.2 includes three evaluation items, each of which is assigned a serial number of 1.2.1, 1.2.2, and 1.2.3. The medium item of 1.3 includes three evaluation items, each of which is assigned a serial number of 1.3.1, 1.3.2, and 1.3.3.

In addition, the ISMS-P certification compliance consists of three major fields (1. Establishment and operation of management system, 2. Protection measures requirements, 3. Requirements for each stage of personal information processing). The major field of ‘1. Establishment and operation of management system’ includes 4 medium fields, 14 sub-fields, and 42 evaluation items. The major field of ‘2. Protection Measures Requirements’ includes 12 medium fields, 64 sub-fields, and 192 evaluation items. The major field of ‘3. Requirements for each stage of personal information processing’ includes 5 medium fields, 22 sub-fields, and 91 evaluation items. Each evaluation item is assigned a serial number to include information on major, medium, and sub-fields.

Depending on compliance, the serial numbers for major, medium, sub-fields and evaluation items may be assigned in Arabic numerals or letters. However, when preparing a report on compliance implementation, compliance implementation inspection and report preparation must be performed based on the established order of the serial number or identification ID for each evaluation item specified in each compliance.

As described above, there are many types of compliance that institutions or companies must adhere to, and the number of evaluation items for each compliance is also very large. This makes it very difficult for a person to manually inspect compliance implementation and to manually create compliance reports.

Accordingly, the industry currently creates a compliance routine program for compliance implementation inspection and report writing, executes the compliance routine program at a specific point in time to inspect implementation, and creates a compliance implementation compliance report based on the results of the implementation inspection.

For any compliance, the major/medium/sub-categories and detailed evaluation items for each evaluation item defined in the compliance are defined, compliance routine programs are created by coding them, the compliance routine programs are executed to inspect compliance implementation, compliance implementation is evaluated, and a report is prepared and submitted to the supervisory institution. If the supervisory institution issues instructions for supplementation, the relevant portion is supplemented or revised and the resubmitted.

Recently, convergence with new technologies such as IoT, artificial intelligence, metaverse, and big data is taking place in all industrial fields, so that cases of enacting or revising laws (laws, enforcement decrees, regulations, and bylaws) are occurring frequently. Further, in some laws, provisions based on technologies that are no longer in use are deleted. In cases where laws, etc., are newly enacted, revised, or deleted, compliance based on such laws, etc., is changed and revised. Each compliance is generally changed and revised annually.

When compliance changes in this way, a compliance routine program before the change may not be used, and the compliance routine program should be recoded based on the changed compliance.

In particular, when a new evaluation item is added in the middle of the evaluation items, or the major/medium/sub-categories of any evaluation item are changed, or the placement order of at least two evaluation items within the sub-category is changed, or the major/medium/sub-categories are deleted, added, or changed in order, the serial number of at least one evaluation item may be newly assigned or changed. At this time, it is very difficult to change the placement locations of the evaluation items in the existing compliance routine program and modify the program code to assign serial numbers by reflecting the placement order of the evaluation items.

Thus, when compliance changes, the compliance routine program before the change should be discarded, and a new compliance routine program should be coded and created based on the compliance after the change.

This incurs high annual maintenance costs for compliance implementation inspections.

### SUMMARY

In view of the above, the present disclosure provides a compliance management system and method using a no-code approach, which allows a manager and multiple inspection personnels to access a compliance management server on a server-client basis and perform compliance management and implementation inspection using the no-code approach.

The present disclosure provides a compliance management system and method using a no-code approach, which can manage compliance using the no-code approach by dividing the compliance into unit policies and placing multiple unit policies according to the hierarchical classification rule of compliance.

The present disclosure provides a compliance management system and method using a no-code approach, which enables serial numbers to be automatically assigned according to classification rules and placement locations of multiple unit policies.

The present disclosure provides a compliance management system and method using a no-code approach, which ensures that the changed detail of the unit policy is reflected in all compliances that include the corresponding unit policy, when the detail of the unit policy is changed.

The present disclosure provides a compliance management system and method using a no-code approach, which allows flexible response to compliance changes without coding.

The present disclosure may be implemented in various ways, including a device (system), a method, a computer program stored in a computer-readable medium, or a computer-readable medium having a computer program stored therein.

A compliance management system using a no-code approach according to an embodiment of the present disclosure may include a compliance management server processing a request from a compliance management client to provide a compliance management function using the no-code approach.

The compliance management server may include a unit policy management module dividing evaluation items included in at least one compliance into unit policies based on a request of the compliance management client, storing the unit policies in a unit policy repository, and individually managing the unit policies, a compliance classification item management module storing at least one hierarchical classification item of compliance in a compliance repository based on the request of the compliance management client, and managing the hierarchical classification item, a compliance evaluation item management module placing at least one unit policy stored in the unit policy repository in a subcategory of the hierarchical classification item of compliance stored in the compliance repository based on the request of the compliance management client, creating a compliance hierarchical structure, and storing it in the compliance repository, and an implementation inspection project management module creating an implementation inspection project based on the compliance hierarchical structure based on the request of the compliance management client, storing the project in an implementation inspection compliance repository, and performing implementation inspection based on the implementation inspection project.

Preferably, the request of the compliance management client may be a query request, and the compliance management client may make the query request to the compliance management server using RESTful application programming interface (API), the compliance management server may call a repository function of an item to be queried, retrieve the queried item data from a data repository using a preset entity manager and JPA Query Factory, input the queried item data into a preset data transfer object (DTO), refine the data through internal data cleansing logic and then includes the queried item data in the RESTful API, and transmit the queried item data to the compliance management client.

Preferably, the request of the compliance management client may be a change request, the compliance management client may transmit FORM data corresponding to the change request to the compliance management server using the RESTful API, and the compliance management server may input the FORM data corresponding to the change request into a preset data transfer object (DTO), refine it through the internal data cleansing logic and then calls a repository function, and use the preset entity manager and JPA query factory to change the data repository in response to the change request.

Preferably, the unit policy management module may receive user input based on a unit policy management screen displayed on the compliance management client, and individually manage the unit policies.

More preferably, the unit policy management screen may include a dashboard display area displaying a menu list, a unit policy source compliance list display area displaying a unit policy source compliance list when the unit policy management menu is selected in the dashboard display area, a unit policy list display area briefly displaying the unit policy list stored in the unit policy repository, and a unit policy detail display area displaying detailed information about one unit policy selected from the unit policy list.

More preferably, the detailed information of the unit policy may include a unique code of the unit policy, a name (item), classification information (field) in the source compliance of the unit policy, a status, a personnel, relevant laws, tags, related policies, attachments, evidential mapping, and detailed guides.

More preferably, the unit policy management module may provide an environment to modify unit policy details pre-stored in the unit policy repository. The unit policy management module may update the detailed information of the unit policy stored in the compliance repository with the modified information, when the unit policy details are modified.

Preferably, the compliance classification item management module may receive user input based on the compliance management screen displayed on the compliance management client, and the compliance classification item management module may manage the hierarchical classification item of the compliance.

More preferably, the compliance evaluation item management module may receive user input based on the compliance management screen, assign at least one unit policy to a subcategory of the hierarchical classification item of the compliance, store the unit policy in the compliance repository, and manage the unit policy.

More preferably, serial numbers may be assigned to unit policies assigned to the subcategory of the hierarchical classification item of the compliance according to placement locations in the subcategory and the hierarchical classification item of the compliance.

According to an embodiment of the present disclosure, in a compliance management server processing a request from a compliance management client to provide a compliance management function using the no-code approach, a compliance management method using a no-code approach implemented by at least one processor may include a unit policy management step of dividing evaluation items included in at least one compliance into unit policies based on a request of the compliance management client, storing the unit policies in a unit policy repository, and individually managing the unit policies, by the compliance management server, a compliance classification item management step of storing at least one hierarchical classification item of compliance in a compliance repository based on the request of the compliance management client, and managing the hierarchical classification item, by the compliance management server, a compliance evaluation item management step of placing at least one unit policy stored in the unit policy repository in a subcategory of the hierarchical classification item of compliance stored in the compliance repository based on the request of the compliance management client, creating a compliance hierarchical structure, and storing the compliance hierarchical structure in the compliance repository, by the compliance management server, and an implementation inspection project management step of creating an implementation inspection project based on the compliance hierarchical structure based on the request of the compliance management client, storing the project in an implementation inspection compliance repository, and performing implementation inspection based on the implementation inspection project, by the compliance management server.

Preferably, the request of the compliance management client may be a query request, and the compliance management client may make the query request to the compliance management server using RESTful API, the compliance management server may call a repository function of an item to be queried, retrieve the queried item data from a data repository using a preset entity manager and JPA Query Factory, input the queried item data retrieved from the data repository into a preset data transfer object (DTO), refine the data through internal data cleansing logic and then includes the queried item data in the RESTful API and transmits the queried item data to the compliance management client.

Preferably, the request of the compliance management client may be a change request, the compliance management client may transmit FORM data corresponding to the change request to the compliance management server using the RESTful API, and the compliance management server may input the FORM data corresponding to the change request into a preset data transfer object (DTO), refine the FORM data through the internal data cleansing logic and then calls a repository function, and use the preset entity manager and JPA query factory to change the data repository in response to the change request.

Preferably, the unit policy management step may receive user input based on a unit policy management screen displayed on the compliance management client, and individually manage the unit policies.

More preferably, the unit policy management screen may include a dashboard display area displaying a menu list, a unit policy source compliance list display area displaying a unit policy source compliance list when the unit policy management menu is selected in the dashboard display area, a unit policy list display area briefly displaying the unit policy list stored in the unit policy repository, and a unit policy detail display area displaying detailed information about one unit policy selected from the unit policy list.

More preferably, the detailed information of the unit policy may include a unique code of the unit policy, a name (item), classification information (field) in the source compliance of the unit policy, a status, a personnel, relevant laws, tags, related policies, attachments, evidential mapping, and detailed guides.

More preferably, the unit policy management step may provide an environment to modify unit policy details pre-stored in the unit policy repository and update the detailed information of the unit policy stored in the compliance repository with the modified information, when the unit policy details are modified.

Preferably, the compliance classification item management step may receive user input based on the compliance management screen displayed on the compliance management client and manage the hierarchical classification item of the compliance.

More preferably, the compliance evaluation item management step may receive user input based on the compliance management screen, assign at least one unit policy to a subcategory of the hierarchical classification item of the compliance, store the unit policy in the compliance repository, and manage the unit policy.

More preferably, unit policies assigned to the subcategory of the hierarchical classification item of the compliance may be stored in the compliance repository based on placement locations in the subcategory and the hierarchical classification item of the compliance, and serial numbers may be assigned to the unit policies.

According to the present disclosure, the following effects are achieved.

The present disclosure allows a manager and multiple inspection personnels to access a compliance management server using a server-client structure and perform compliance management and implementation inspection using the no-code approach.

The present disclosure can manage compliance using a no-code approach by dividing the compliance into unit policies and placing multiple unit policies according to the hierarchical classification rule of compliance.

The present disclosure enables serial numbers to be automatically assigned according to changed classification rules and placement locations when the classification rules and placement locations of a plurality of unit policies are changed.

The present disclosure allows flexible response to compliance changes without coding, thereby reducing maintenance costs incurred during compliance implementation inspection.

Effects of the present disclosure are not limited to the above-mentioned effects, and other effects that are not mentioned above will be clearly understood by those skilled in the art from the following claims.

### BRIEF DESCRIPTION OF THE DRAWINGS

Hereinafter, the embodiments of the present disclosure will be described with reference to the accompanying drawings, in which like reference numerals refer to like parts throughout various figures and embodiments of the present disclosure.

FIG. 1 illustrates an example of an environment in which a compliance management system using a no-code approach according to the present disclosure may operate.

FIG. 2 is a block diagram illustrating the compliance management system using the no-code approach according to the present disclosure.

FIG. 3 is a diagram illustrating the layout of a unit policy management screen displayed in the compliance management client according to an embodiment of the present disclosure.

FIG. 4 is a diagram illustrating the layout of a unit policy registration screen displayed in the compliance management client according to an embodiment of the present disclosure.

FIG. 5 is a diagram illustrating the layout of a compliance management screen displayed in the compliance management client according to an embodiment of the present disclosure.

FIG. 6 is an operation flowchart showing a compliance management method using a no-code approach according to an embodiment of the present disclosure.

### DETAILED DESCRIPTION

Hereinafter, specific details for carrying out the present disclosure will be described in detail with reference to the accompanying drawings. However, when it is determined that the detailed description of the known art related to the present disclosure may obscure the gist of the present disclosure, the detailed description will be omitted.

In the accompanying drawings, the same reference numerals are used to designate the same or similar components. Further, in the description of embodiments below, redundant description of the same or similar components will be omitted. However, even if the description of components is omitted, it is not intended to imply that the components are not included in any embodiment.

The above and other objectives, features, and other advantages of the present disclosure will be more clearly understood from the following detailed description when taken conjointly with the accompanying drawings. The present disclosure may, however, be embodied in many different forms. These embodiments are provided solely to ensure that this disclosure is complete and will fully convey the scope of the invention to those skilled in the art.

Unless otherwise defined, the terms or words used in the specification should not be interpreted as being limited merely to common and dictionary meanings. In addition, terms defined in a commonly used dictionary are not to be interpreted ideally or excessively unless explicitly defined otherwise.

For example, the term “technology” may refer to a system, a method, a computer readable instruction, a module, an algorithm, hardware logic, and/or an operation as permitted by the context described above and throughout the document.

The terms used herein will be briefly described, and the disclosed embodiment will be described in detail. In the description of the present disclosure, terms are defined in consideration of the functions of components of the present disclosure. Because the terms can be differently defined according to the intention of a user or an operator or customs, these terms should be interpreted as having a meaning that is consistent with the technical spirit of the present disclosure. In certain cases, there are terms that are arbitrarily selected by the applicant. In this case, their meanings will be described in detail in the description of the relevant invention. Therefore, the terms used herein should be defined based on the meaning of the terms and the overall content of the present disclosure, rather than simply the names of the terms.

In the present disclosure, the singular forms are intended to include the plural forms as well, unless the context clearly indicates otherwise. Further, the plural forms are intended to include the singular forms as well, unless the context clearly indicates otherwise. When it is described herein that a part includes a certain component, this means that it further includes other components rather than excluding them, unless otherwise specially stated.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In the present disclosure, when a certain component is referred to as being “coupled”, “combined”, “connected”, “associated” or “reacting” with any other component, the certain component may be directly coupled, combined, connected, associated, or react with another component, but are not limited thereto. For example, one or more intervening components may be present between the certain component and another component. Further, in the present disclosure, “and/or” may include each of one or more listed items or a combination of at least some of one or more listed items.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure.

In the present disclosure, the term “compliance” refers to a regulation or rule that an institution or company should comply with, and may be issued in the form of a document by a compliance supervisory institution or certification institution. Each institution or company should submit a compliance report on compliance required in its industry sector to the relevant compliance supervisory institution or certification institution. The compliance supervisory institution or certification institution may change the compliance each year and provide it to the relevant institution or company in the form of a document. At this time, the compliance change details may be provided in a comparison table of items before and after the change.

In the present disclosure, the term “standard compliance” may mean compliance established by a compliance supervisory institution or certification institution based on laws, etc. As described above, the standard compliance may include Anti-Money Laundering (AML) compliance required of financial institutions, Know-Your-Customer (KYC) compliance, transaction record preservation compliance, local regulatory compliance, personal information protection-related compliance, e-finance infrastructure security vulnerability assessment compliance, e-finance transaction law-related compliance, Information Security Management System (ISMS) compliance, ISMS-P certification compliance based on ISO/IEC 27001, financial information protection continuous evaluation system compliance, technical vulnerability analysis and assessment compliance of key information and communication infrastructure, and Financial Supervisory Service certification and verification compliance. In the case of standard compliance, the hierarchical classification regulations, evaluation items belonging to each classification, evaluation methods, and implementation evidential materials may be organized and provided by the relevant compliance supervisory institution or certification institution. In the present disclosure, the term “non-standard compliance” may be compliance operated by the company itself. A company can define its own classification rules, evaluation items, evaluation methods, and implementation evidential materials, and can integrate multiple standard compliances into a single non-standard compliance.

In the present disclosure, the term “compliance hierarchical structure” may be composed of hierarchical classification items and evaluation items specified in compliance. The classification items may be classification information for each evaluation item. Classification items may include major categories, medium categories, and subcategories, and may also be named as categories, major items (major fields), medium items (medium fields), and medium items (sub-fields) depending on standard compliance. In the present disclosure, major items (major fields) are named as major categories, medium items (medium fields) are named as medium categories, and medium items (sub-fields) are named as subcategories. Depending on compliance, the compliance hierarchical structure may be composed of a two-level classification system among major-, medium-, and sub-categories, or the compliance hierarchical structure may be composed of a four-level classification system by including an additional classification level.

In the present disclosure, the term “unit policy” may be an individual evaluation item or individual policy item included in each compliance. Typically, compliance may be composed of multiple evaluation items, and each evaluation item may include classification information (major, medium, subcategories). In the present disclosure, individual evaluation items included in each compliance are named as unit policies. The compliance management system using the no-code approach according to the present disclosure can individually store and manage each unit policy, create a compliance hierarchical structure by combining multiple unit policies, and create an implementation inspection project based on the compliance hierarchical structure thus created.

A manager can access the compliance management system using the no-code approach according to the present disclosure to create a compliance hierarchical structure based on the hierarchical classification rules and evaluation items of compliance. The compliance hierarchical structure can be created based on standard compliance or based on non-standard compliance that companies operate on their own. The compliance management system using the no-code approach according to the present disclosure can create an implementation inspection project for inspecting compliance implementation based on the compliance hierarchical structure.

The compliance management system using the no-code approach described below constitutes one embodiment and is not intended to limit the claims to any one particular operating environment. The compliance management system may also be used in other environments without departing from the technical scope of the claimed subject matter.

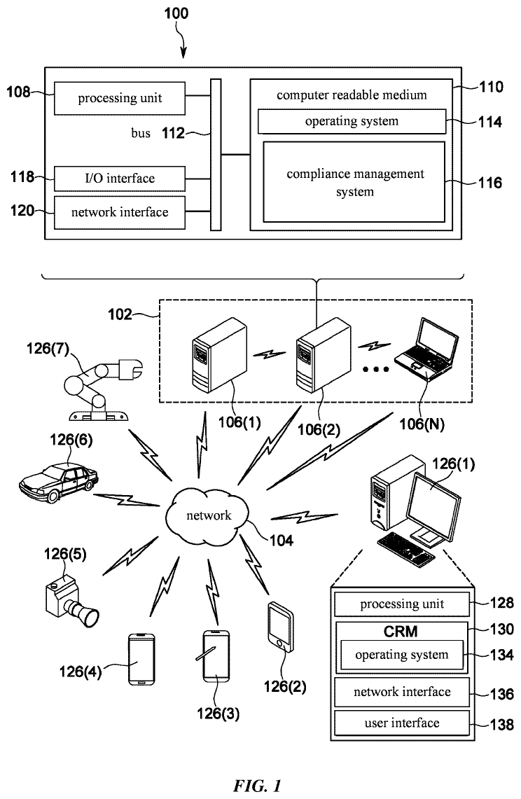

FIG. 1 illustrates an exemplary environment 100 in which a compliance management system using a no-code approach according to the present disclosure may operate. In some examples, various devices and/or components of the environment 100 may include distributed computer resources 102 that may communicate with each other and an external device via one or more networks 104.

The network 104 may include a public network such as the Internet, a private network such as an institutional and/or private intranet, or some combination of private and public networks. The network 104 may include any type of wired and/or wireless network, including but not limited to a local area network (LAN), a wide area network (WAN), a satellite network, a cable network, a Wi-Fi network, a WiMax network, a mobile network (e.g., 3G, 4G, 5G, etc.), or any combination thereof. The network 104 may utilize a communication protocol including packet-based and/or datagram-based protocols such as Internet Protocol (IP), Transmission Control Protocol (TCP), User Datagram Protocol (UDP), or other types of protocols. Furthermore, the network 104 may include a plurality of devices that facilitate network communications or form a hardware foundation for the network, such as switches, routers, gateways, access points, firewalls, base stations, repeaters, and backbone devices.

The network 104 may further include devices that enable connection to a wireless network, such as a wireless access point (WAP). Embodiments according to the present disclosure may support connections via the WAP that transmits and receives data via various electromagnetic frequencies (e.g., radio frequencies), including the WAP that supports the Institute of Electrical and Electronics Engineers (IEEE) 802.11 standard (e.g., 802.11g, 802.11n, etc.).

The distributed computer resource 102 may include devices 106(1) to 106(N). An embodiment of the present disclosure may support a scenario where the device 106 may include one or more computer devices operating in a cluster or other grouped configuration to share resources, distribute load, increase implementation, or for other purposes. The device 106 may be a compliance management server 106.

The compliance management server 106 may include any type of computer device having one or more processing units 108 operably connected to a computer readable medium (CRM) 110 via a bus 112. The bus 112 may include a system bus, a data bus, an address bus, a Peripheral Component Interconnect (PCI) bus, a mini PCI bus, and various local, peripheral, and/or independent buses.

Executable instructions stored in the CRM 110 may include, for example, other modules, programs or applications loadable and executable by an operating system 114, part 116 of the compliance management system according to the present disclosure and the processing unit 108. Further, a function described herein may be performed at least in part by one or more hardware logic components, such as an accelerator. For example, the available hardware logic component may include a Field-Programmable Gate Array (FPGA), Application-Specific Integrated Circuits (ASIC), Application-Specific Standard Products (APS), a System-on-a-Chip System (SOC), a complex programmable logic device (CPLD), etc.

The compliance management server 106 includes one or more input/output (I/O) interfaces 118 that enable the compliance management server 106 to communicate with a peripheral input device (e.g., a keyboard, mouse, pen, game controller, voice input device, touch input device, gesture input device, etc.) and/or a peripheral output device (e.g., a display, printer, touchscreen, etc.). For convenience, other components are omitted from the illustrated compliance management server 106.

The compliance management server 106 may include one or more input/output (I/O) network interfaces 120. The input/output (I/O) network interface 120 may include one or more network interface controllers (NIC) or other types of transceiver devices for transmitting and receiving communications over the network 104.

In the present disclosure, another device related to the compliance management may include a plurality of compliance management clients 126(1) to 126(7). The plurality of compliance management clients 126 may include a manager client used by a compliance manager and an inspection personnel client used by a compliance inspection personnel. The manager client and the inspection personnel client are not physically fixed devices, but they may be computer devices used by a manager and an inspection personnel to access the compliance management server 106.

The compliance management client 126 may belong to various categories, such as a desktop computer-type device, a mobile device, a special purpose device, an embedded device, and/or a wearable device. The compliance management client 126 may have fewer computer resources than the compliance management server 106 and may comprise various device types.

The compliance management client 126 may include a desktop computer 126(1), a satellite-based navigation system device 126(2) including a global positioning system (GPS) device, a tablet computer or tablet hybrid computer 126(3), a smart phone, a mobile phone, a mobile phone-tablet hybrid device, or other communication devices 126(4), a camera or personal video recorder (PVR) 126(5), an automotive computer such as a vehicle control system or vehicle security system 126(6), a mechanical robot device 126(7), and the like, without being limited to a specific device type.

The compliance management client 126 may be any type of computer device having one or more processing units 128 operably connected to the computer-readable medium (CRM) 130 via the bus, which may include more system buses, data buses, address buses, PCI buses, mini PCI buses, and various local, peripheral, and/or independent buses.

The CRM 110 or 130 described herein may include a computer storage medium and/or a communication medium. The computer storage medium may include any type of storage unit, removable and non-removable computer storage media, such as a volatile memory, a nonvolatile memory, and/or other permanent and/or auxiliary computer storage media implemented in any method or technology for storage of information such as computer-readable instructions, data structures, program modules, or other data.

The computer storage medium may be random-access memory (RAM), static RAM (SRAM), dynamic RAM (DRAM), phase change memory (PRAM), read-only memory (ROM), erasable programmable read-only memory (EPROM), electrically erasable programmable read-only memory (EEPROM), flash memory, digital versatile disc (DVD), an optical storage medium, a magnetic cassette, magnetic tape, solid state memory (SSD), etc.

The executable instructions stored in the CRM 130 included in the compliance management client 126 may include modules, programs or applications that are loadable and executable by the operating system 134 and the processing unit 128. The compliance management client 126 may include at least a portion of the compliance management system according to the present disclosure.

Additionally or alternatively, a function described herein may be performed at least in part by one or more hardware logic components, such as an accelerator. For example, types of available hardware logic components may include a Field-Programmable Gate Array (FPGA), Application-Specific Integrated Circuits (ASIC), Application-Specific Standard Products (APS), a System-on-a-Chip System (SOC), a complex programmable logic device (CPLD), etc.

The compliance management client 126 may also communicate with the compliance management server 106 over the network 104 by including one or more input/output (I/O) interfaces including one or more network interfaces 136 and a user interface 138. Such a network interface 136 may include one or more network interface controllers (NIC) or other types of transceiver devices for transmitting and receiving communications over the network.

The compliance management client 126 may also include a user interface 138 to receive input from the manager or inspection personnel.

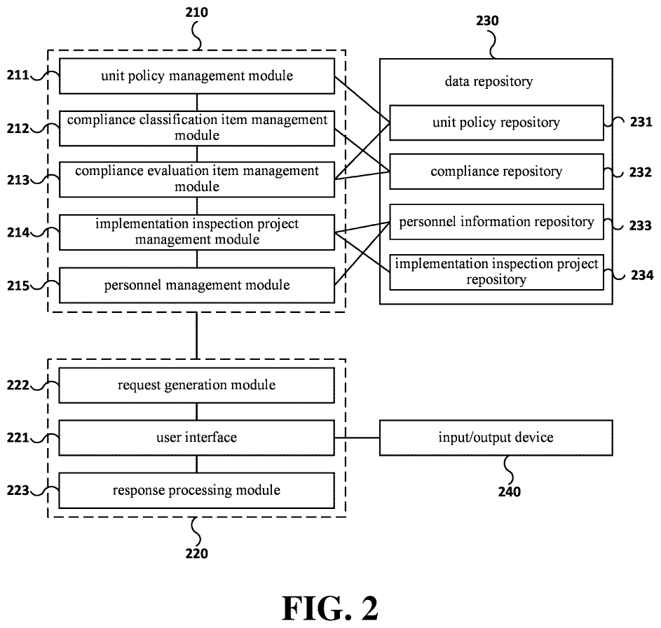

FIG. 2 is a block diagram illustrating the compliance management system using the no-code approach according to the present disclosure.

The compliance management system using the no-code approach according to the present disclosure may include a compliance management server 210, a compliance management client 220, and a data repository 230. The compliance management server 210 and the compliance management client 220 each include a network interface to enable mutual communication via a network. The compliance management server 210 may be the compliance management server 106 of FIG. 1, and the compliance management client 220 may be the compliance management client 126 of FIG. 1.

The compliance management server 210 may include a unit policy management module 211 that stores unit policies in a unit policy repository 231 and manages the unit polices individually, a compliance classification item management module 212 that manages the hierarchical classification items of the compliance, a compliance evaluation item management module 213 that manages the unit policies assigned to the subcategory of the hierarchical classification items of the compliance, an implementation inspection project management module 214 that creates an implementation inspection project for compliance implementation inspection based on a compliance hierarchical structure and manages an implementation inspection process, and a personnel management module 215 that manages a compliance manager and an inspection personnel for each implementation inspection item. The unit policy management module 211, the compliance classification item management module 212, the compliance evaluation item management module 213, the implementation inspection project management module 214, and the personnel management module each may be combined to be performed by a smaller number of modules and/or APIs, or each may be divided and performed by a larger number of modules and/or APIs.

The compliance management client 220 may include a user interface 221 that receives a user input through an input/output device 240 and displays a response from the compliance management server 210 on the input/output device 240, a request generation module 222 that generates a request corresponding to the user input received through the user interface 221 and transmits it to the compliance management server 210, and a response processing module 223 that receives a response to a request from the compliance management server 210 and outputs it through the user interface 221 to the input/output device 240. The user input may be made through a character key input using a keyboard device, a function key input using a keyboard device, a drag and drop input using a mouse device, a virtual function key click input using a mouse device, etc. The compliance management client 220 may be a computer system used by the compliance manager to access the compliance management server 210.

The compliance management server 210 provides a standardized Hypertext Transfer Protocol (HTML)-based form (FORM) to the compliance management client 220. When a user provides the user input through the character key input, the function key input, the drag-and-drop operation, and the virtual function key click input, the request generation module 222 of the compliance management client 220 transmits FORM data corresponding to the user input to the compliance management server 210 using a RESTful API (Representational State Transfer API), and the compliance management server 210 operates with a function corresponding to the called RESTful API.

### Query Request Processing Process

The request may be a query request, such as a request to view a compliance list, a request to view a hierarchical classification item list, a request to view a unit policy list, or a request to view unit policy details. Based on the user input, the request generation module 222 transmits the query request to the compliance management server 210 using the RESTful API. The compliance management server 210 calls a repository function according to the item to be queried, retrieves the queried item data from the data repository 230 using a preset entity manager and a JPA Query Factory, inputs the queried item data retrieved from the data repository 230 into a preset data transfer object (DTO), refines the data through internal data cleansing logic and then includes the queried item data in the RESTful API and transmits it to the compliance management client 220. The response processing module 223 of the compliance management client 220 uses an element plus library to display the requested queried item data as the user input to the input/output device 240.

### Change Request Processing Process

Meanwhile, the request may be a change request, such as a request to add, modify, or delete the hierarchical classification item of the compliance, a request to add, modify, or delete the unit policy, or a request to add, modify, or delete an evaluation item included in the subcategory of the hierarchical classification item. Based on the user input, the request generation module 222 transmits a change request, such as the addition, modification, or deletion of the hierarchical classification item, the unit policy, or the evaluation item, to the compliance management server 210. The compliance management client 220 transmits FORM data corresponding to the change request to the compliance management server 210 using the RESTful API. The compliance management server 210 inputs the FORM data corresponding to the change request into a preset data transfer object (DTO), refines it through the internal data cleansing logic and then calls a repository function appropriate to the function, and uses the preset entity manager and the JPA query factory to perform a change corresponding to the user input in the data repository 230. That is, data in the data repository 230 corresponding to the user input may be changed by adding, modifying, deleting, etc. If the change to the data repository 230 for the user input data is successful, a change success message is sent to the compliance management client 220 as a response to the request. When a change to the data repository 230 for the user input is completed, the query request may be generated so that the changed information may be displayed on the input/output device.

The data repository 230 may include a unit policy repository 231 that stores information about the unit policy, a compliance repository 232 that stores information about the compliance, a personnel information repository 233 that stores information about a personnel, and an implementation inspection project repository 234 that stores information about an implementation inspection project.

The unit policy management module 211 stores and manages each individual evaluation item included in any compliance as the unit policy. Information about the unit policy managed by the unit policy management module 211 may include compliance information that is the source of the unit policy, the policy code of the unit policy (unique code or self-assigned code), the name of the unit policy, the publication date of the unit policy, classification item information (field) in the source compliance of the unit policy, tags, key information on items to be verified in the unit policy, implementation/compliance guide, evidential information, evidential mapping information, relevant law information, and relevant policy information, etc. Information about the unit policy may be stored in the unit policy repository 231. Here, the relevant policy information may be stored by linking unit policy information of other compliances that are similar or identical to the corresponding unit policy.

The request generation module 222 of the compliance management client 220 may receive the user input through the user interface 221 and request a query for details of the unit policy, the unit policy management module 211 may transmit the detailed data of the corresponding unit policy stored in the unit policy repository 231 to the compliance management client 220, and the response processing module 223 of the compliance management client 220 may display details of the unit policy to the input/output device 240.

Further, the compliance management client 220 may transmit a change request to modify the details of the unit policy or add or delete the unit policy based on the user input to the compliance management server 210. In response to the change request, the unit policy management module 211 may add, change, or delete the unit policy in the unit policy repository 231 and transmit a response to the change request to the compliance management client 220. The response processing module 223 displays the response from the compliance management server 210 to the input/output device 240 through the user interface 221. At this time, the unit policy management module 211 may also manage the registration and detailed content modification history of the unit policy.

The processing processes for a query request for the details of the unit policy and a request for change on the details of the unit policy between the compliance management server 210 and the compliance management client 220 are substantially the same as the [query request processing process] and [change request processing process] described above, respectively.

The compliance classification item management module 212 manages the hierarchical classification item of the compliance. The compliance may include major/medium/sub-category information according to a hierarchical classification system, and may include at least one evaluation item in a sub-category classified into major/medium/sub-category. The compliance classification item management module 212 stores and manages classification item information based on the hierarchical classification system specified in standard compliance or non-standard compliance.

The request generation module 222 of the compliance management client 220 receives user input through the user interface 221 and transmits a query request for the hierarchical classification item of compliance to the compliance management server 210. The compliance classification item management module 212 may read the hierarchical classification item of the corresponding compliance stored in the compliance repository 232 and transmit the item to the compliance management client 220. The response processing module 223 of the compliance management client 220 may display the hierarchical classification item list of the compliance on the input/output device 240.

Further, the compliance management client 220 may transmit a change request to the compliance management server 210 to add, modify, or delete the hierarchical classification item of compliance based on the user input. In response to such a change request, the compliance classification item management module 212 may add, change, or delete the hierarchical classification item of compliance stored in the compliance repository 232 and transmit a response to the change request to the compliance management client 220.

The response processing module 223 displays the response from the compliance management server 210 to the input/output device 240 through the user interface 221. When the compliance changes to a new version, a user may request a change to the hierarchical classification item to reflect the changed compliance. The compliance classification item management module 212 responds to such a request to change the compliance hierarchical classification item stored in the compliance repository 232 and responds to the compliance management client 220 so that the changed hierarchical classification item is displayed on the input/output device 240.

The processing processes for a query request for the compliance hierarchical classification item and a change request for the compliance hierarchical classification item between the compliance management server 210 and the compliance management client 220 are substantially the same as the [query request processing process] and [change request processing process] described above, respectively.

The compliance evaluation item management module 213 manages unit policies belonging to the subcategory of the hierarchical classification item of the compliance. The compliance evaluation item management module 213 enables a list of unit policies contained in the subcategory classified by the hierarchical classification system to be viewed, and at least one unit policy may be added, changed, or deleted within the subcategory. The operations of viewing the unit policy list, adding, changing, and deleting the unit policy may be performed at the request of the compliance management client 220. Multiple unit policies placed in one subcategory may have their placement locations changed or may have their placement changed to subcategories of other major or medium categories. The compliance evaluation item management module 213 may assign serial numbers to the classification items of the unit policies and placement positions within the subcategories. For instance, with the classification items of a 3rd major category/2nd medium category/1st subcategory, the unit policy of the 2nd placement position in the relevant subcategory may be given a serial number of 3.2.1.2. Further, when the placement position of the unit policy is moved to the 1st placement position of the classification item of the 3rd major category/2nd medium category/1st subcategory, the unit policy is given a new serial number of 3.2.1.1.

When a user requests a change in placement location for any unit policy, the compliance evaluation item management module 213 of the compliance management server 210 ensures that the request for the change in placement location for the corresponding unit policy is reflected in the compliance repository 232, and the compliance evaluation item management module 213 automatically assigns a serial number to each unit policy based on the classification rule and placement location in the compliance repository 232 where the change is reflected.

The request generation module 222 of the compliance management client 220 receives the user input through the user interface 221 and transmits a query request for a list of unit policies included in the compliance subcategory to the compliance management server 210. The compliance evaluation item management module 213 may read the list of unit policies included in the subcategory of the corresponding compliance stored in the compliance repository 232 and transmit the list to the compliance management client 220. The response processing module 223 of the compliance management client 220 may display the list of compliance unit policies to the input/output device 240.

Further, the compliance management client 220 may transmit a change request to the compliance management server 210 to add the unit policies included in the subcategory of the compliance, modify or delete the placement location based on the user input. In response to such change request, the compliance evaluation item management module 213 may add the unit policies included in the subcategory of the compliance stored in the compliance repository 232, modify or delete the placement location, and transmit a response to the change request to the compliance management client 220.

When the user input is to add the unit policy, the placement location information of the added unit policy is also transmitted, and the compliance evaluation item management module 213 adds the requested additional unit policy to the placement location of the existing unit policy list of the compliance repository 232 and assigns a new serial number according to the placement location of the existing unit policy list and the requested additional unit policy.

When the user input is to delete the unit policy, the deleted unit policy information is sent, and the compliance evaluation item management module 213 deletes the unit policy requested for deletion from the existing unit policy list of the compliance repository 232 and assigns a new serial number to the unit policy list to reflect the deleted unit policy.

When the user input is to modify the unit policy placement location, the placement location information of the changed unit policy is transmitted together, and the compliance evaluation item management module 213 changes the placement locations of existing unit policy lists in the compliance repository 232 and assigns new serial numbers to the unit policy lists according to the changed placement locations.

The response processing module 223 displays a response from the compliance management server 210 to the input/output device 240 via the user interface 221. That is, unit policies included in the subcategory are displayed with serial numbers according to their placement locations.

The processing processes for a query request for the unit policy list included in the subcategory of the compliance and a change request for the unit policy list included in the subcategory of the compliance between the compliance management server 210 and the compliance management client 220 are substantially the same as the [query request processing process] and [change request processing process] described above, respectively.

Because the compliance evaluation items may be managed by dividing them into unit policies and new serial numbers may be assigned according to the classification items and placement locations of the unit policies, users may easily respond in a no-code manner even if compliance changes.

By the operations of the compliance classification item management module 212 and the compliance evaluation item management module 213, the compliance hierarchical structure may be formed. The compliance hierarchical structure may be configured by assigning a plurality of unit policies according to the hierarchical classification system of compliance.

The implementation inspection project management module 214 may create an implementation inspection project for implementation inspection based on the compliance hierarchical structure and manage the implementation inspection process. The implementation inspection project management module 214 may be driven by user input and may create the implementation inspection project based on the compliance hierarchical structure created by the compliance classification item management module 212 and the compliance evaluation item management module 213. The implementation inspection project may be composed of a plurality of implementation inspection items, and each implementation inspection item may correspond to each unit policy included in the compliance hierarchical structure.

The implementation inspection project management module 214 may store the implementation inspection project in the implementation inspection project repository 234, receive inspector information for each implementation inspection item that constitutes the implementation inspection project through the compliance management client 220, and store it in the implementation inspection project repository 234.

Subsequently, when each inspection personnel accesses the compliance management server 210 using the compliance management client, the implementation inspection management module 132 enables implementation inspection to be performed by mapping evidential material for each evaluation item assigned to each inspection personnel. The implementation inspection project management module 214 may also generate an implementation compliance report based on the implementation inspection result.

The personnel management module 215 may manage compliance manager information and inspection personnel information for each compliance inspection item of the compliance inspection project. The personnel management module 215 may acquire the manager information and the inspection personnel information from the compliance management client 220. The personnel management module 215 may obtain information such as each personnel's identification ID, company name, business field, compliance field, unit policy, field of responsibility, contact information, and email address and store the information in the personnel information repository 234.

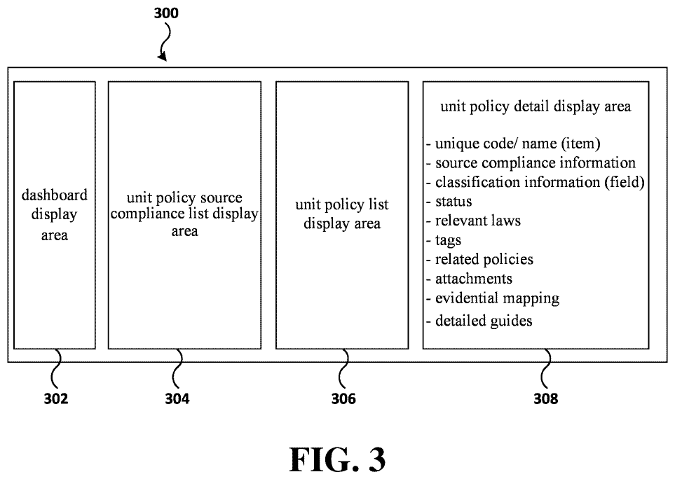

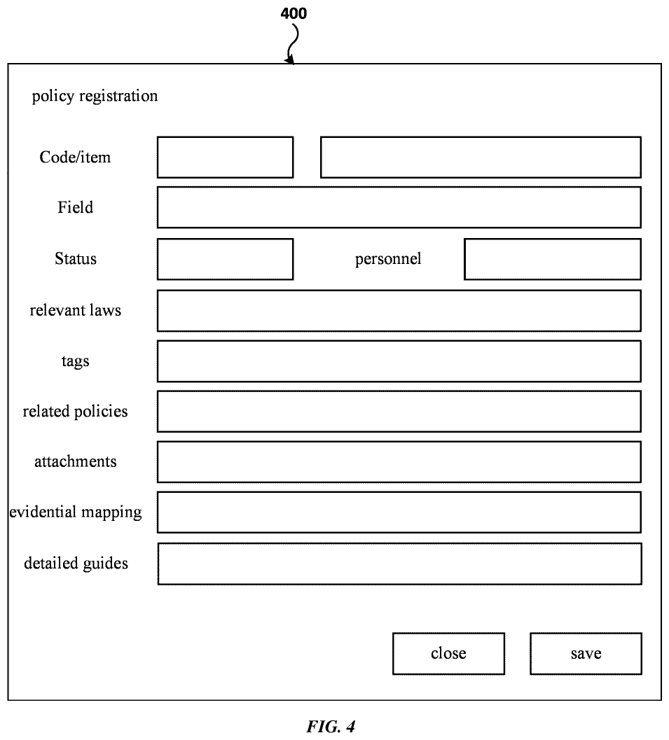

FIG. 3 is a diagram illustrating the layout of a unit policy management screen 300 displayed in the compliance management client according to an embodiment of the present disclosure, and FIG. 4 is a diagram illustrating the layout of a unit policy registration screen 400 displayed in the compliance management client according to an embodiment of the present disclosure.

The compliance management client 220 receives user input through an interface with the user based on the unit policy management screen 300 and transmits a request based on the user input to the compliance management server 210. The compliance management server 210 supports to individually manage unit policies based on a request according to user input.

The unit policy management screen 300 may include a dashboard display area 302 that displays a menu list provided by the compliance management system using the no-code approach according to the present disclosure, a unit policy source compliance list display area 304 that displays a unit policy source compliance list when the unit policy management menu is selected in the dashboard display area 302, a unit policy list display area 306 that briefly displays the unit policy list stored in the unit policy repository 231 of the compliance management server 210, and a unit policy detail display area 308 that displays detailed information about one unit policy selected from the unit policy list.

To display the unit policy source compliance list and the unit policy list on the unit policy management screen 300, the request generation module 222 of the compliance management client 220 transmits a query request for the unit policy source compliance list and a query request for the unit policy list to the compliance management server 210. The unit policy management module 211 of the compliance management server 210 calls a repository function according to the unit policy source compliance list and the unit policy list to be queried, retrieves the queried item data from the unit policy repository 231 using a preset entity manager and a JPA Query Factory, inputs the queried item data into a preset data transfer object (DTO), refines the data through internal data cleansing logic, and then transmits the data to the compliance management client 220 using the RESTful API. The response processing module 223 of the compliance management client 220 uses an element plus library to display the unit policy source compliance list and the unit policy list according to the user input on the input/output device 240.

Generally, the compliance includes a plurality of evaluation items. In the present disclosure, the evaluation items included in the compliance are managed as the unit policy. Compliance from which individual unit policies are derived is referred to as unit policy source compliance. As shown in FIG. 3, the unit policy source compliance list display area 304 of the unit policy management screen 300 may display the unit policy source compliance list and display the number of unit policies extracted for each unit policy source compliance. Further, in the unit policy list display area 306, the unit policy list stored in the unit policy repository 231 may be displayed along with brief information. All unit policy lists may be displayed at once. When any unit policy source compliance is selected from the unit policy source compliance list, only the unit policies derived from that compliance may be collected and displayed.

The unit policy detailed information is displayed on the unit policy detail display area 308. The unit policy detailed information may include the unique code of the unit policy, a name (item), classification information (field) in the source compliance of the unit policy, a status, a personnel, relevant laws, tags, related policies, attachments, evidential mapping, detailed guides, etc.

The unit policy detailed information may receive information from the unit policy registration screen 400 of FIG. 4 and be stored in the unit policy repository 231. Here, relevant policy information may be stored by linking unit policy information of other compliances that are similar or identical to the corresponding unit policy. The tag may be additional information given by a user to categorize and search for similar unit policies.

The unit policy management module 211 may receive information on the unit policy from the compliance management client 220 through the unit policy registration screen 400 of FIG. 4 and then store and manage the information, or the unit policy management module 211 may receive information from a computer system of a compliance management specialized company through a network and then store the information in the unit policy repository 231 and manage the information.

The unit policy management module 211 provides an environment in which the unit policy detailed information in the unit policy detail display area 308 may be modified. This allows a user to open and modify pre-stored unit policy detailed information when the compliance changes. When the user inputs information to add, modify, or delete unit policy details, the request generation module transmits a request to change the corresponding unit policy details to the compliance management server 210. The compliance management client sends FORM data corresponding to the user input to the compliance management server using the RESTful API. The compliance management server inputs the FORM data into a preset data transfer object (DTO), refines the data through internal data cleansing logic, and then calls a repository function according to the function. The unit policy management module 211 makes a change corresponding to the user input to the unit policy repository 231 using a preset entity manager and a JPA Query Factory. That is, the unit policy corresponding to the user input may be added, modified, or deleted. The unit policy management module 211 changes data in the unit policy repository 231 in response to the user input and transmits a change success message as a response to the request to the compliance management client 220. At this time, when the query request occurs, the unit policy detail screen reflecting the changed information may be displayed on the input/output device 240.

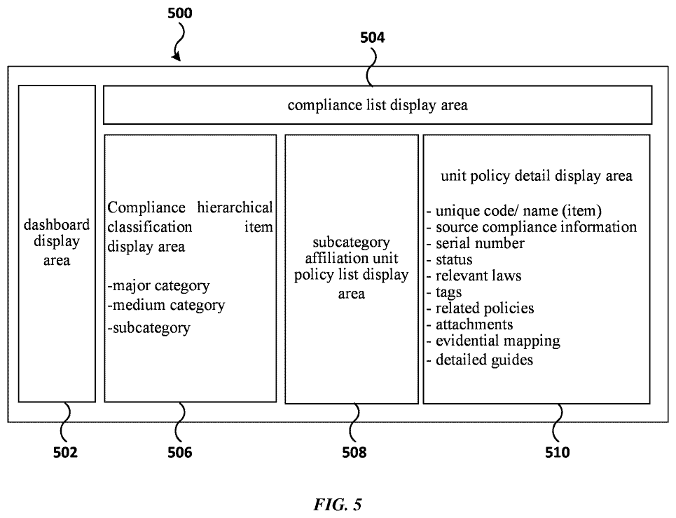

FIG. 5 is a diagram illustrating the layout of a compliance management screen 500 displayed in the compliance management client according to an embodiment of the present disclosure.

The compliance management client 220 receives user input through an interface with the user based on the compliance management screen 500 and transmits a request based on the user input to the compliance management server 210. The compliance management server 210 supports to manage the hierarchical classification item of compliance based on the request according to the user input.

The compliance management screen 500 may include a dashboard display area 502 that displays a menu list provided by the compliance management system using the no-code approach according to the present disclosure, a compliance list display area 504 that displays a compliance list when the compliance management menu is selected in the dashboard display area 502, and a compliance hierarchical classification item display area 506 that displays the hierarchical classification system information of the compliance selected from the compliance list.

To display the compliance list and a subcategory affiliation unit policy list on the compliance management screen 500, the request generation module 222 of the compliance management client 220 transmits a query request for the compliance list and a query request for the subcategory affiliation unit policy list to the compliance management server 210. The compliance classification item management module 212 and the compliance evaluation item management module 213 of the compliance management server 210 call a repository function according to the compliance list and the subcategory affiliation unit policy list to be queried, retrieves the queried item data from the compliance repository 232 using a preset entity manager and a JPA Query Factory, inputs the queried item data into a preset data transfer object (DTO), refines the data through internal data cleansing logic, and then transmits the data to the compliance management client 220 using the RESTful API. The response processing module 223 of the compliance management client 220 uses an element plus library to display the compliance list and the subcategory affiliation unit policy list according to user input on the input/output device 240.

The compliance hierarchical classification items displayed in the compliance hierarchical classification item display area 506 may include at least one of a major category, a medium category, and a subcategory. For example, the hierarchical classification item may be composed of two, three, or four hierarchies. Each major category included in one compliance may have a different number of hierarchies. For example, some major categories may have three hierarchies, and some may have four hierarchies.

For example, in the case of the hierarchical classification items of compliance with the Financial Information Protection Continuous Evaluation System, two hierarchies (which may be defined as the major category/subcategory) may exist. As the major category, included may be ‘Principles and methods of consent to personal credit information’, ‘Collection of personal credit information’, ‘Provision of personal credit information’, ‘Retention and deletion of personal credit information’, ‘Guarantee of rights of credit information subjects’, etc. For example, the third major category, ‘Provision of Personal Credit Information’, may include subcategories such as ‘Provision of Personal Credit Information’ and ‘Conclusion of Security Agreement Related to Provision of Personal Credit Information’. The number of unit policies included in each major category and subcategory may be indicated in the compliance hierarchical classification item.

The compliance classification item management module 212 may store and manage classification item information based on a hierarchical classification system specified in standard compliance or non-standard compliance. The compliance classification item management module 212 may receive hierarchical classification item information of compliance from the compliance management client 220 and then store and manage the compliance classification item management module 212. The compliance classification item management module 212 may receive the hierarchical classification item information of compliance through a network from a computer system of a compliance management specialized company and then store and manage the hierarchical classification item information of compliance. The compliance classification item management module 212 may provide an environment to add, delete, and change hierarchical classification items of any compliance. Thus, when the compliance changes to a new version, the hierarchical classification items may be changed to reflect the changed compliance.

The compliance classification item management module 212 may receive the hierarchical classification item of compliance through the compliance management screen 500 of FIG. 5 and then store and manage the hierarchical classification item of compliance in the compliance repository 232.

When a user inputs a request to add, modify, or delete a compliance hierarchical classification item on the compliance management screen 500, the request generation module 222 transmits a request to change the corresponding hierarchical classification item to the compliance management server 210. The compliance management client transmits FORM data corresponding to the user input to the compliance management server using the RESTful API. The compliance management server inputs the FORM data into a preset data transfer object (DTO), refines the data through the internal data cleansing logic, and then calls a repository function appropriate to the function. The compliance classification item management module 212 uses the preset entity manager and the JPA query factory to perform a change corresponding to the user input in the compliance repository 232. That is, the hierarchical classification item of compliance corresponding to the user input may be added, modified, or deleted. The compliance classification item management module 212 changes data in the compliance repository 231 in response to the user input and transmits a change success message as a response to the request to the compliance management client 220. At this time, when the query request occurs, the compliance management screen reflecting the changed information may be displayed on the input/output device 240. The compliance management client 220 receives user input through an interface with the user based on the compliance management screen 500 and transmits a request based on the user input to the compliance management server 210. The compliance management server 210 supports to manage the hierarchical classification item of compliance based on the request according to the user input.

The compliance management screen 500 may include a subcategory affiliation unit policy list display area 508 that displays the unit policy list assigned to the subcategory in the hierarchical classification system of compliance and a unit policy detail display area 510 that displays the detailed information of the unit policy selected from the subcategory affiliation unit policy list.

The compliance evaluation item management module 213 may input allocation information of unit policies into the subcategory of the hierarchical classification item of compliance based on the compliance management screen 500 and then the compliance evaluation item management module 213 may store and manage the input allocation information of unit policies in the compliance repository 232. The detailed information of unit policies stored in this compliance repository 232 may be modified to reflect the change when the unit policy repository 231 is changed by the unit policy management module 211.

The compliance evaluation item management module 213 may add, modify, or delete at least one unit policy within the subcategory divided into the hierarchical classification system. Operations to add, modify, and delete the unit policy may be performed by a user. A plurality of unit policies assigned to a single subcategory may have their placement locations changed or may have their placement locations changed to subcategories of other major or medium categories. The compliance evaluation item management module 213 may assign serial numbers to the classification items and placement positions within the subcategories of each unit policy.

The compliance management client 220 may send a change request to the compliance management server 210 to add, modify the placement location, or delete the unit policy included in the subcategory of compliance according to the user input. In response to such a change request, the compliance assessment item management module 213 may add, modify the placement location, or delete unit policies included in the subcategory of compliance stored in the compliance repository 232. The compliance assessment item management module 213 may transmit a response to the change request to the compliance management client 220.

When a user inputs information to add, modify the placement location, or delete the subcategory affiliation unit policy in the compliance management screen 500, the request generation module 222 transmits a request to change the corresponding subcategory affiliation unit policy to the compliance management server 210. The compliance management client sends FORM data corresponding to user input to the compliance management server using the RESTful API. The compliance management server inputs the FORM data into a preset data transfer object (DTO), refines the data through internal data cleansing logic, and then calls a repository function according to the function. The compliance evaluation item management module 213 makes a change corresponding to the user input to the compliance repository 232 using a preset entity manager and a JPA Query Factory. That is, the subcategory affiliation unit policy corresponding to the user input may be added, modified in placement location, or deleted. The compliance evaluation item management module 213 assigns a new serial number to each subcategory affiliation unit policy according to the changed placement location and transmits the new serial number to the compliance management client 220.

When the user input is to add the subcategory affiliation unit policy, the placement location information for the unit policy requesting the addition is also transmitted, and the compliance evaluation item management module 213 adds and stores the unit policy requesting the addition to the placement location of the existing unit policy list of the compliance repository 232. A new serial number is assigned to each subcategory affiliation unit policy according to the existing subcategory affiliation unit policy list and the placement location of the unit policy requesting the addition.

When the user input is to delete the subcategory affiliation unit policy, information on the unit policy requesting the deletion is transmitted, and the compliance evaluation item management module 213 deletes the unit policy requesting the deletion from the existing unit policy list of the compliance repository 232. New serial numbers are assigned to the remaining subcategory affiliation unit policies.

When the user input is to modify the placement location of the subcategory affiliation unit policy, the placement location information of the unit policies having changed locations is also transmitted. That is, when the placement order of the second and third unit policies in the subcategory affiliation unit policy list is switched, the switched placement location information is also transmitted. The compliance evaluation item management module 213 changes the placement locations of two unit policies in the existing unit policy list of the compliance repository 232 and assigns new serial numbers to subcategory affiliation unit policies according to the changed placement locations.

The unit policies of compliance may be changed in classification item and placement location. A compliance supervisory institution or certification institution may annually modify the detailed information of unit policies, but the compliance supervisory institution or certification institution may change the hierarchical classification item, may place the unit policies in different classification items than before, or may change the placement locations of multiple unit policies included in the same classification item. Conventionally, there is a problem that the compliance routine program should be recoded when the classification items or placement locations of compliance unit policies are changed.

However, according to the present disclosure, when a user changes the classification items and placement locations of unit policies, the subcategory affiliation unit policy information stored in the compliance repository may be changed according to the user input, and a new serial number may be assigned to each unit policy based on the changed subcategory affiliation unit policy information.

As an example, in the compliance hierarchical classification item, the major category ‘Provision of personal credit information’ and the subcategory ‘Provision of personal credit information’ may have two unit policies (‘Consent when providing personal credit information’ and ‘In case of providing or receiving personal credit information without consent, prior notice of the fact and reason for providing it’). The hierarchical classification items and subcategory affiliation unit policies may be stored in the compliance repository 232 in order, and a serial number may be assigned to each subcategory affiliation unit policy based on the stored information.

According to the present disclosure, when the classification items or placement locations of subcategory affiliation unit policies are changed as the user input, the compliance evaluation item management module may change the storage order of the subcategory affiliation unit policies in the compliance repository 232 in response to the user input, and a new serial number may be assigned to each subcategory affiliation unit policy based on the changed storage order.

By the operation of the compliance classification item management module 212 and the compliance evaluation item management module 213, the compliance hierarchical structure may be formed. The compliance hierarchical structure may be configured by assigning a plurality of unit policies according to the hierarchical classification system of compliance, and the compliance hierarchical structure may be stored in the compliance repository 232.

The implementation inspection project management module 214 may create an implementation inspection project for implementation inspection based on the compliance hierarchical structure stored in the compliance repository 232 and store the implementation inspection project in the implementation inspection project repository 234. The implementation inspection project may correspond to a conventional compliance routine program and may be created using the no-code approach. The implementation inspection project management module 214 may be driven by a user's instruction. The implementation inspection project may be created based on the compliance hierarchical structure created by the compliance classification item management module 212 and the compliance evaluation item management module 213. The implementation inspection project may be composed of a plurality of implementation inspection items, and each implementation inspection item may correspond to each unit policy included in the compliance hierarchical structure. Even if the detailed information of the unit policy is changed by the unit policy management module 211, it is preferable to perform the implementation inspection based on the details of the unit policy before the change, as it is not reflected in the implementation inspection items of the implementation inspection project created based on the unit policy.

The implementation inspection project management module 214 may store the implementation inspection project in the implementation inspection project repository 234, receive inspection personnel information for each implementation inspection item that forms the implementation inspection project through the compliance management client 220, and store the inspection personnel information in the implementation inspection project repository 234.

Subsequently, when each inspection personnel accesses the compliance management server 210 using the compliance management client, the implementation inspection management module 132 enables implementation inspection to be performed by mapping evidential material for each evaluation item assigned to each inspection personnel. The implementation inspection project management module 214 may also generate an implementation compliance report based on the implementation inspection result.

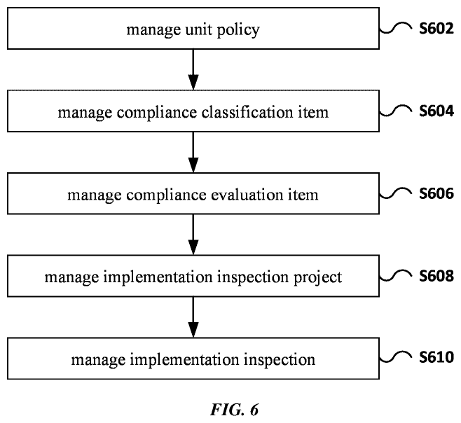

FIG. 6 is an operation flowchart showing a compliance management method using a no-code approach according to an embodiment of the present disclosure.

The operation of the exemplary process is illustrated by individual blocks and described with reference to these blocks. The process is depicted as the logical flow of the blocks, and each block may represent one or more operations that may be implemented in hardware, software, or a combination thereof. In the context of software, the operations represent computer executable instructions stored in one or more computer readable media that, when executed by one or more processors, cause the one or more processors to perform the above-mentioned operations. Typically, the computer executable instructions include routines, programs, objects, modules, components, data structures, and those that perform a particular function or implement a particular abstract data type. The order in which the operations are described should not be construed as restrictive, and the described operations may be subdivided into multiple sub-operations, or executed in parallel, in any order.

The compliance management server stores unit policies in the unit policy repository 231 and manages them individually (S602).

The compliance management server stores the hierarchical classification item of compliance in the compliance repository 232 and manages the item (S604).

The compliance management server creates the compliance hierarchical structure by placing at least one unit policy stored in the unit policy repository 231 as the subcategory of the hierarchical classification item of compliance stored in the compliance repository 232, stores the structure in the compliance repository 232, and manages the structure (S606).

The compliance management server generates the implementation inspection project based on the compliance hierarchical structure, stores the project in the implementation inspection project repository 234, and manages the project (S608).

The compliance management server manages the implementation inspection based on the implementation inspection project stored in the implementation inspection project repository 234 (S610).

All of the methods and processes described above may be implemented as software code modules executed by one or more general-purpose computers or processors and may be fully automated. The code module may be stored in any type of computer readable storage medium or other computer storage devices. Some or all of the methods may be implemented using special computer hardware.

Any description, element, or block of the flowchart described herein and/or depicted in the accompanying drawings should be understood as potentially representing code, a module, a segment, or a portion that contains one or more executable instructions for implementing a particular logical function or element. Alternative examples are included within the scope of the examples described herein, and elements or functions may be deleted or executed in sequence from that illustrated or discussed, substantially synchronously, or in reverse order, as may be understood herein.

It should be understood that many variations and modifications may be made to the embodiments described above, and the element is one of several acceptable examples. All the modifications and variations are intended to be included within the scope of this disclosure and protected by the following claims. The above-described embodiments of the present disclosure may be implemented in the form of program commands that may be executed through various computer components and recorded on a computer-readable recording medium. The computer-readable recording medium may include program commands, data files, data structures, etc., alone or in combination. The program commands recorded on the computer-readable recording medium may be those specially designed and configured for the present disclosure or may be known and available to those skilled in the art of computer software. Examples of computer-readable recording media include magnetic media such as hard disks, floppy disks, and magnetic tape, optical recording media such as compact disc read-only memories (CD-ROMs) and DVDs, magneto-optical media such as floptical disks, and hardware devices specifically configured to store and execute program commands, such as ROM, RAM, and flash memory. Examples of program commands include not only machine language code, such as that produced by a compiler, but also high-level language code that may be executed by a computer using an interpreter, etc. The above hardware device may be configured to operate as one or more software modules to perform processing according to the present disclosure, or vice versa.

Although the present disclosure has been described above with specific details such as specific components and limited examples and drawings, they are provided only to help a more general understanding of the present disclosure, and the present disclosure is not limited to the above examples, and those with ordinary knowledge in the technical field to which the present disclosure pertains may make various modifications and variations based on this description.

Therefore, it is to be understood that the idea of the present disclosure is not limited to the above-described embodiments, and all changes within meets and bounds of the claims or equivalents of such meets and bounds fall within the scope of the present disclosure.

The following is a list of reference numbers used in this description and the drawings.
210: compliance management server
211: unit policy management module
212: compliance classification item management module
213: compliance evaluation item management module
214: implementation inspection project management module
215: personnel management module
220: compliance management client
221: user interface
222: request generation module
223: response processing module
230: data repository
231: unit policy repository
232: compliance repository
233: personnel information repository
234: implementation inspection project repository
240: input/output device

1. A compliance management system using a no-code approach, the system comprising:
a compliance management server processing a request from a compliance management client to provide a compliance management function using the no-code approach,
wherein the compliance management server comprises:
a unit policy management module dividing evaluation items included in at least one compliance into unit policies based on a request of the compliance management client, storing the unit policies in a unit policy repository, and individually managing the unit policies;
a compliance classification item management module storing at least one hierarchical classification item of compliance in a compliance repository based on the request of the compliance management client, and managing the hierarchical classification item;
a compliance evaluation item management module placing at least one unit policy stored in the unit policy repository in a subcategory of the hierarchical classification item of compliance stored in the compliance repository based on the request of the compliance management client, creating a compliance hierarchical structure, and storing it in the compliance repository; and
an implementation inspection project management module creating an implementation inspection project based on the compliance hierarchical structure based on the request of the compliance management client, storing the project in an implementation inspection compliance repository, and performing implementation inspection based on the implementation inspection project.

2. The compliance management system of claim 1,
wherein the request of the compliance management client is a query request, and
wherein the compliance management client makes the query request to the compliance management server using RESTful API, and
wherein the compliance management server calls a repository function of an item to be queried, retrieves queried item data from a data repository using a preset entity manager and JPA Query Factory, inputs the queried item data retrieved from the data repository into a preset data transfer object (DTO), refines the queried data through internal data cleansing logic and then includes the queried item data in the RESTful API and transmits the queried item data to the compliance management client.

3. The compliance management system of claim 1,
wherein the request of the compliance management client is a change request,
wherein the compliance management client transmits FORM data corresponding to the change request to the compliance management server using RESTful API, and
wherein the compliance management server inputs the FORM data corresponding to the change request into a preset data transfer object (DTO), refines the FORM data through internal data cleansing logic and then calls a repository function, and uses a preset entity manager and JPA query factory to change a data repository in response to the change request.

4. The compliance management system of claim 1, wherein the unit policy management module receives user input based on a unit policy management screen displayed on the compliance management client, and individually manages the unit policies.

5. The compliance management system of claim 4, wherein the unit policy management screen comprises:
a dashboard display area displaying a menu list;
a unit policy source compliance list display area displaying a unit policy source compliance list when the unit policy management screen is selected in the dashboard display area;
a unit policy list display area briefly displaying the unit policy list stored in the unit policy repository; and
a unit policy detail display area displaying detailed information about one unit policy selected from the unit policy list.

6. The compliance management system of claim 5, wherein the detailed information of the unit policy comprises a unique code of the unit policy, a name (item), classification information (field) in the source compliance of the unit policy, a status, a personnel, relevant laws, tags, related policies, attachments, evidential mapping, and detailed guides.

7. The compliance management system of claim 5, wherein the unit policy management module provides an environment to modify unit policy details pre-stored in the unit policy repository, and updates the detailed information of the unit policy stored in the compliance repository as modified information, when the unit policy details are modified.

8. The compliance management system of claim 1, wherein the compliance classification item management module receives user input based on the compliance management screen displayed on the compliance management client, and manages the hierarchical classification item of the compliance.

9. The compliance management system of claim 8, wherein the compliance evaluation item management module receives user input based on the compliance management screen, assigns at least one unit policy to a subcategory of the hierarchical classification item of the compliance, stores the unit policy in the compliance repository, and manages the unit policy.

10. The compliance management system of claim 9, wherein serial numbers are assigned to unit policies assigned to the subcategory of the hierarchical classification item of the compliance according to placement locations in the subcategory and the hierarchical classification item of the compliance.

11. A compliance management method using a no-code approach implemented by at least one processor, in a compliance management server processing a request from a compliance management client to provide a compliance management function using the no-code approach, the method comprising:
a unit policy management step of dividing evaluation items included in at least one compliance into unit policies based on a request of the compliance management client, storing the unit policies in a unit policy repository, and individually managing the unit policies, by the compliance management server;
a compliance classification item management step of storing at least one hierarchical classification item of compliance in a compliance repository based on the request of the compliance management client, and managing the hierarchical classification item, by the compliance management server;
a compliance evaluation item management step of placing at least one unit policy stored in the unit policy repository in a subcategory of the hierarchical classification item of compliance stored in the compliance repository based on the request of the compliance management client, creating a compliance hierarchical structure, and storing it in the compliance repository, by the compliance management server; and
an implementation inspection project management step of creating an implementation inspection project based on the compliance hierarchical structure based on the request of the compliance management client, storing the project in an implementation inspection compliance repository, and performing implementation inspection based on the implementation inspection project, by the compliance management server.

12. The compliance management method of claim 11,
wherein the request of the compliance management client is a query request, and
wherein the compliance management client makes the query request to the compliance management server using RESTful API, and
wherein the compliance management server calls a repository function of an item to be queried, retrieves queried item data from a data repository using a preset entity manager and JPA Query Factory, inputs queried item data retrieved from the data repository into a preset data transfer object (DTO), refines the queried item data through internal data cleansing logic and then includes the queried item data in the RESTful API and transmits the queried item data to the compliance management client.

13. The compliance management method of claim 11,
wherein the request of the compliance management client is a change request,
wherein the compliance management client transmits FORM data corresponding to the change request to the compliance management server using RESTful API, and
wherein the compliance management server inputs the FORM data corresponding to the change request into a preset data transfer object (DTO), refines the FORM data through internal data cleansing logic and then calls a repository function, and uses a preset entity manager and JPA query factory to change a data repository in response to the change request.

14. The compliance management method of claim 11, wherein the unit policy management step receives user input based on a unit policy management screen displayed on the compliance management client, and individually manages the unit policies.

15. The compliance management method of claim 14, wherein the unit policy management screen comprises:
a dashboard display area displaying a menu list;
a unit policy source compliance list display area displaying a unit policy source compliance list when the unit policy management screen is selected in the dashboard display area;
a unit policy list display area briefly displaying the unit policy list stored in the unit policy repository; and
a unit policy detail display area displaying detailed information about one unit policy selected from the unit policy list.

16. The compliance management method of claim 15, wherein the detailed information of the unit policy comprises a unique code of the unit policy, a name (item), classification information (field) in the source compliance of the unit policy, a status, a personnel, relevant laws, tags, related policies, attachments, evidential mapping, and detailed guides.

17. The compliance management method of claim 15, wherein the unit policy management step provides an environment to modify unit policy details pre-stored in the unit policy repository, and updates the detailed information of the unit policy stored in the compliance repository as modified information, when the unit policy details are modified.

18. The compliance management method of claim 11, wherein the compliance classification item management step receives user input based on the compliance management screen displayed on the compliance management client, and manages the hierarchical classification item of the compliance.

19. The compliance management method of claim 18, wherein the compliance evaluation item management step receives user input based on the compliance management screen, assigns at least one unit policy to a subcategory of the hierarchical classification item of the compliance, stores the unit policy in the compliance repository, and manages the unit policy.

20. The compliance management method of claim 19, wherein unit policies assigned to the subcategory of the hierarchical classification item of the compliance are stored in the compliance repository based on placement locations in the subcategory and the hierarchical classification item of the compliance, and serial numbers are assigned to the unit policies.
